(19) United States
(12) Patent Application Publication
(10) Pub. No.: US 2002/0050753 A1
(43) Pub. Date: May 2, 2002

(54) Rotor of the closed type for impactors

(76) Inventors: Volker Heukamp, Lengerich (DE); Gerhard Hemesath, Havixbeck (DE)

Correspondence Address: STRIKER, STRIKER & STENBY, 103 East Neck Road, Huntington, NY, 11743, US

(21) Appl. No.: 09/966,446

(22) Filed: Sep. 28, 2001

(30) Foreign Application Priority Data
Sep. 30, 2000 (DE) 100 48 698.3
Aug. 31, 2001 (DE) 101 42 765.4

(51) Int. Cl. H02K 5/00; H02K 15/00

(52) U.S. Cl. 310/89; 310/42

(57) ABSTRACT

A rotor of the closed type for impactors, produced from cast steel, as a casing and the rotor discs carrying this area cast in one piece, the rotor casing being of essentially single-walled design, and the circumferential slots for receiving the beater bars being provided in the cast body itself. Alternatively to this, the rotor casing may be subdivided into shells which are connected outside the circumferential slots by means of longitudinal weld seams to form a closed rotor casing, the rotor casing likewise being connected to the rotor discs carrying the latter by means of weld seams.

### BACKGROUND OF THE INVENTION

The present invention relates to a rotor of the closed type for impactors.

More particularly, the present invention relates to a rotor of the closed type for impactors, which has the rotor body consisting of a cylinder-like casing and of rotor discs carrying the latter on a shaft and being produced from cast steel, the rotor casing being provided on the outside with circumferential slots oriented parallel to the rotor axis and intended for receiving and holding beater bars.

A rotor of this type is known from German Utility Model 1831058 and is designed here as a rotor for centrifugal impactors. The cylinder-like rotor casing—the term “cylinder” is not to be understood literally, the shape may also correspond to a straight prism, as here in the prior art—is formed, in this design, from spacer pieces which have hollow chambers and, arranged between rotor discs, are welded to these. The spacer pieces are likewise welded to one another, specifically in the bottom of the circumferential slots of the rotor casing which receive the beater bars. These circumferential slots also pass through the outer rotor discs, so that the beater bars are introduced axially into the slots and are held radially, counter to the centrifugal force, by means of undercuts of the circumferential slots and by means of ribs cast onto the beater bars. Said spacer pieces have on their end faces tenons which are inserted into bores of the discs and are welded therein. Although the utility model specification mentioned does not imply the material steel casting or cast steel, the proprietor mentioned in the utility model specification is the legal predecessor of the current applicant, so that there is a corresponding level of knowledge here.

However, the production of such a rotor is highly complicated. Apart from the fact that the patterns for the spacer pieces are very costly because of their hollow space and the complicated shaping and, at the same time, lost pattern cores also have to be used, it has been shown, in practice, that the necessary weight tolerances with respect to the centre of gravity of the individual spacer pieces cannot be maintained, so that an unbalance which cannot be compensated occurs when the rotor rotates at high speed. A particular disadvantage, however, is the weld seam provided in the bottom of the circumferential slots in order to connect the spacer pieces to one another, since it is very difficult to guide conventional welding tongs through the circumferential slots to the connection point. Furthermore, the bores in the lateral rotor discs have to be produced with great accuracy in relation to the tenons of the spacer pieces and to the welds in the bottom of the circumferential slots in order to avoid an unbalance in the rotor. Since the circumferential slots in the rotor casing are intended for receiving the beater bars in each case between two cast bodies which cannot be welded sufficiently precisely to one another, the hold of the beater bars both in the radial direction and with respect to their installation position is inaccurate per se, and, in the case of beater bars made of cast materials with a high degree of hardness, this may even lead to fractures. This can be remedied only if the seats of the beater bars are machined mechanically after the assembly of the rotor, thus leading to an increase in costs.

The results of all these difficulties is that rotors of this type have achieved virtually no acceptance on the market.

### SUMMARY OF THE INVENTION

Accordingly, it is an object of the present invention to improve a rotor of the type mentioned in the introduction, in such a way that these problems outlined do not arise and the rotor is also simple and inexpensive to produce. At the same time, the aim of the invention is, along with a weight saving, as compared with the rotor according to the prior art, to improve the mass of inertia by shifting the masses outwards.

In keeping with these objects and with others which will become apparent hereinafter, one feature of present invention resides, briefly stated, in a rotor of the closed type for impactors, in which the rotor casing and the rotor discs carrying the latter are cast in one piece and the rotor casing is of an essentially single-walled design, the circumferential slots for receiving and holding the beater bars being provided in the cast body itself. Substantially more accurate dimensions with respect to the contour of the circumferential slots are thereby achieved, so that mechanical reworking is unnecessary. Owing to the single-walled design of the rotor casing, there is a saving in terms of cast material or the latter is placed further outwards, thus improving the mass moment of inertia of the finished rotor. In the case of the rotor according to the invention, the moulding of the pattern is simpler, which as the advantage of a further cost saving.

This advantage has a particular effect in the case of narrow impactors, since, here, the rotor casing needs to have only one rotor disc which is held tensionally locked on the shaft by means of a clamping element or clamping assembly. If appropriate, the rotor disc is equipped with a wider hub which receives the clamping element or a plurality of these.

For wider impactors, too, however, this form of construction is particularly advantageous, in that the rotor casing is subdivided into annular disc elements, and each disc element is provided with a rotor disc which is held tensionally locked on the shaft by means of a clamping element or clamping assembly and a rotor consisting of a plurality of disc elements is thus formed.

U.S. Pat. No. 3,151,816 discloses a rotor of the closed type for impactors, which moreover also has a disc-like design, but the discs use are burnt out from sheets of mild steel and are assembled by welding to form the rotor body. In this case, not every disc is held on the shaft, but only the outer discs and the disc in the middle. The discs located between them are formed from disc rings with a larger inside diameter, so that inner joint weld seams can additionally be applied as a result. This form of construction is complicated and costly, especially since the elements are not cast from casting steel. According to the invention, in the case of rotors for wider impactors, there is also no need for the annular disc elements to be connected to one another by means of weld seams. The disc connected bear with their outer rings against one another and thus form the closed rotor casing characteristic of the closed form of construction in question here.

However, a preferred design of the rotor according to the invention is also afforded when the rotor casing is subdivided into shells which are connected outside the circumferential slots for the beater bars by means of longitudinal weld seams, to form a closed rotor casing, with the result that the circumfential slots for receiving and holding the beater bars are provdied in the cast body itself and the rotor casing is connected to the rotor discs carrying it, likewise by means of weld seams.

The number of shells is obtained from the number of beater bars provided according to the rotor size and the intended use. This, in a further refinement of the invention, there is provision for the rotor casing to be formed from 4 shells, of which the longitudinal weld seams connecting these are provided in radially outer slot-like depressions of the rotor casing which run parallel to the circumferential slots for the beater bars, and for these depressions to be arranged, in the direction of rotation of the rotor, upstream of the beater bars or upstream of the circumferential slots for receiving the beater bars.

It is advantageous if the shells are of hollow design and the hollow spaces have radially and circumferentially oriented reinforcing ribs, and if the reinforcing ribs terminate inwards with a radius which corresponds to the radius of the rotor discs.

It is also advantageous if the slot-like depressions and therefore the weld seams are covered by plates which, having form-fitted guide pieces, can be pushed axially into the depressions and are held by means of the form-fitted connection against the centrifugal forces directed outwards. These plates effectively protect the weld seams, but also at the same time the rotor casing which is exposed at this point, just in front of the beater bars, to particularly high stress which causes wear. They are moreover easily exchangeable.

The invention provides, furthermore, for the rotor casing to be subdivided into segments which, starting from the beater bars, have, opposite to the direction of rotation of the rotor, a spiral generated surface inclined in the direction of the axis. A casing surface inclined in this way, however, is known from DE-A-1 053 899 in the case of a rotor of conventional form of construction (no construction from casting steel).

The invention is applied to particular advantage when use is made of beater bars capable of being acted upon on one side, which are capable of being inserted in a form-fitted manner into circumferential slots of the rotor and have rearwards, opposite to the direction of rotation of the rotor, and facing the latter, a bend, by means of which they engage into a longitudinally running undercut of the circumferential slots and are held counter to the centrifugal force of the rotating rotor, with a bearing surface, by means of which the beater bars are held against a bearing surface of the rotor, and with a supporting surface, via which the beater bars are in engagement with the undercut in the circumferential slots by means of a supporting or bearing piece. For this purpose, according to the invention, in order to hold the beater bars at their arcuately designed bends, the circumferential slots in the rotor casing have, as a bearing surface, an approximately radially oriented plane which extends over the width of the rotor rand runs out into the arcuately designed undercut, and the circumferential slots have, opposite this arcuate supporting surface, with the thickness of the beater bars taken into account, the centre of rotation of the smaller radius of the arc on the bearing surfaces being arranged at a considerable distance from the centre of rotation of the larger radius of the arc on the supporting surface, in the direction of the beating circle of the beater bar, and the two centres of rotation running in a line approximately parallel to the beating surface of the beater bar, the bearing surfaces being at an obtuse angle to one another in the prolongation of the smaller arc. In this case, it is advantageous if the distance between the centres of rotation of the radii is in a ratio of 1:7 to 1:15, preferably 1:10, to the remaining height of the beater bars installed in the rotor.

Thus, also advantageously, the angle between the bearing surfaces lying in the prolongation of the smaller arc will amount to 120°.

It is advantageous if the supporting or bearing piece is designed exchangeably.

In a further refinement of the invention, there is provision for the circumferential slots for receiving the beater bars to have, on their inner, approximately radially extending boundary surface oriented longitudinally over the rotor width, a segment-shaped recess facing the end on the bend of the beater bars and extending over the width of the rotor, so that a profile bar, which preferably consists of plastic, can be introduced into the free space between the segment-shaped recess in the circumferential slots and a segment-shaped recess of the installed beater bars.

In a further embodiment of the invention, there is mounted, in the region of the bearing surfaces for the beater bars, a boss which projects somewhat beyond the bearing surfaces and over which a recess provided in the beater bars can be slipped. A lateral retention of the beater bars is consequently achieved in a particularly simple way when these are tilted into the working position (in bearing contact with the bearing surface).

Rotors for impactors with beaters capable of being acted upon on one side are known in many forms. For example, U.S. Pat. No. 3,151,816 shows such a rotor, the rotor body, as mentioned above, being welded together from individual discs. The beater bars used here are likewise bent rearwards, but at right angles, and engage under an undercut of the circumferential slots in the rotor body. The beater bars have, on their front side, a bevel which faces the rotor via which the beater bars are supported against wedges, with the result that the beater bars are held in engagement with the undercut. The beater bars are therefore clamped firmly by mean of the wedges are not self-locking. They are also not capable of being tilted off over a rounded undercut and are therefore more difficult to remove. This also applies to other known rotors, the beater bars of which are also secured to the rotor body by means of screw connections in addition to wedge-shaped supporting (German Patent Specification 16 07 552, Australian Patent Specification 253 653).

Rotors for impactors, the rotor body of which is produced, complete, from cast steel, are known from DE 41 02 692 C1 and DE 198 13 310 C1. These publications show discs which are welded to one another at their hubs and which have edge clearances aligned with one another and intended for receiving the beater bars. These are what are known as open disc rotors, in which the problems which the invention is set to solve in relation to rotors of the closed type do not even arise. These rotors are of a different generic type.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a cross section of the rotor with installed beater bars, in accordance with the present invention;

FIG. 2 shows a longitudinal section through the rotor with an inserted shaft, in accordance with the present invention;

FIG. 3 shows a detail from FIG. 1 on a larger side, in accordance with the present invention;

FIG. 4 shows a side view of an alternative design of the rotor, in accordance with the present invention;

FIG. 5 shows a longitudinal section through a rotor for wider impactors which is composed of a plurality of disc elements, in accordance with the present invention, and

FIG. 6 shows a detail of FIG. 4 on a larger side, in accordance with the present invention.

### DESCRIPTION OF THE PREFERRED EMBODIMENTS

As shown in FIG. 1, the rotor 1 consists of a rotor casing 2 which is composed of four shells 3. The shells have circumferential slots 4 which run parallel to the rotor axis Z (with respect to the finished rotor) and into which the beater bars 5 are inserted. The shells 3 are connected to one another outside the circumferential slots by means of longitudinal weld seams 6 to form an annular structure, the rotor casing 2.

So that these longitudinal weld seams are protected against wear, they are provided in slot-like depressions 7 which are arranged parallel to the circumferential slots and which are half-formed from the longitudinal edges 8 of the shells 3. The depressions 7 have guide pieces 9, into which guide pieces 10 engage, to create form-fitting guides 11. The form-fitting guide pieces 10 are attached to the underside of plates 12 which can consequently be pushed axially into the depressions. The plates 12 cover the longitudinal weld seams 6 and protect these against wear. At the same time, compensating weights may be introduced into the depressions 7 if such weights become necessary during the balancing of the rotor. The plates themselves are produced from highly wear-resistant material, but may also be protected on their surface by means of surface welds with materials suitable for this purpose.

The rotor casing 2, which may also be cast in one piece, is subdivided in a known way into segments 13 which, starting from the beater bars 5, have, opposite to the direction of rotation of the rotor 1, an inclined spiral generated surface 14 in the direction of the axis Z. As illustrated in the example, the segments 13 or shells 3 may be of hollow design, in which case it is expedient to provide reinforcing ribs 16 in the hollow spaces 15, these reinforcing ribs and the longitudinal edges 8 of the rotor casing 2 forming inwards a circular termination 17, via which the rotor casing is supported on at least two rotor discs provided at both ends of the rotor.

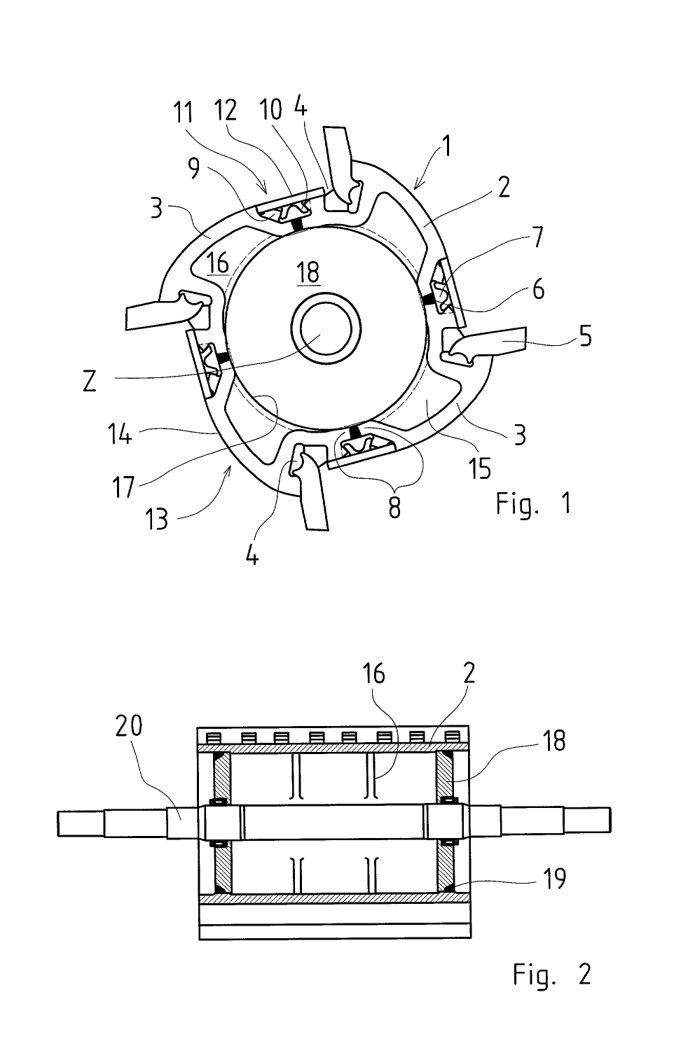

In this case, as is evident from FIG. 2, the rotor casing 2 is welded to the rotor discs 18 by means of weld seams 19, but may also be cast from one piece together with the rotor discs if the rotor casing 2 is not subdivided into shells 3. As also shown in FIG. 2, further reinforcing ribs 16 are provided further inwards outside the rotor discs. This figure also depicts a shaft 20 which is inserted into the rotor by means of known fastening elements.

As FIG. 1 makes clear, the circumferential slots 4 for the beater bars 5 are provided in the cast body itself.

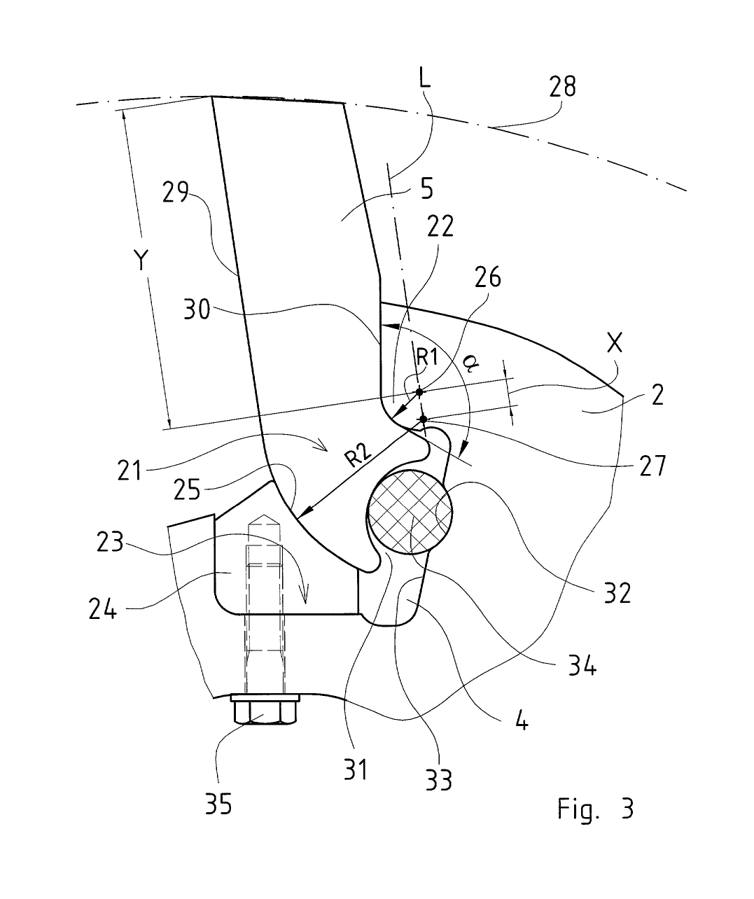

FIG. 3 shows in detail, on a larger scale, the preferred embodiment of the invention which is tailored to beater bars capable of being acted upon on one side. The rotor casing 2 has a number of circumferential slots 4, into which the beater bars 5 are pushed from the side. The beater bars themselves have an arcuate bend 21 at their longitudinal end facing the rotor and consequently engage under an arcuate undercut 22 of the circumferential slots, with the result that they are held against being thrown out. Opposite the arcuate undercut are provided, in the bottom 23 of the circumferential slots, bearing pieces 24 which likewise have an arcuate surface as the supporting surface 25. The radius R1 of the arcuate undercut 22 and the radius R2 of the arcuate supporting surface 25 not only differ in terms of the thickness of the beater bars, but their centres of rotation are also arranged at a distance from one another, specifically the centre of rotation 26 of the smaller radius R1 on the undercut 22 is arranged at a distance of dimension X from the centre of rotation 27 of the larger radius R2 of the arc on the supporting surface, in the direction of the beating circle 28, the two centres of rotation being oriented in a line L approximately parallel to the front surface 29 of the beater bar.

The beater bars 5 are supported on a plane bearing surface 30 of each circumferential slot, said bearing surface extending over the width of the rotor 1 and guiding the energy of the rotor into the beater bars. In this case, the bearing surface 30 runs at an obtuse angle to the bearing surface at the outer end of the smaller arc.

What is achieved by this design of the hold of the beater bars is that, in the working position, the beater bars are self-locked between the arcuate supporting surface 25 and the arcuately designed undercut 22 and are therefore fully secured against flying out of the rotating rotor. What is thereby achieved, on the other hand, is that, between the bearing surface 30 and the surface of the undercut 22 and also the supporting surface 25 and the corresponding surfaces of each beater bar 5, when the latter is in the installation position, there are no gaps in which fine material can settle. The removal of the beater bars become very simple. These need merely to be tilted somewhat forwards, with the result that, due to the arrangement of the centres of rotation 26/27, the locking of the beater bars is released and a gap occurs between the contact surfaces, so that the beater bars can easily be drawn out laterally. So that, when the rotor 1 starts up or slows down, the beater bars 5 do not unintentionally tip down and rattle, this being made easier by the gaps occurring at the same time, the beater bars have, on the end face of their bend 21 which faces the rotor, a segment-shaped recess 31 which extends over the length of the beater bars and which matches with a corresponding recess 32 in the approximately radially extending boundary surface 33 of the circumferential slots 4 of the rotor, said boundary surface being oriented longitudinally over the rotor width. A round profile bar 34, which is expediently produced from plastic, can be introduced between these recesses which together form a circular cross section.

The bearing pieces 24 are expediently fitted exchangeably and are fastened to the rotor casing 2 by means of screw connections 35.

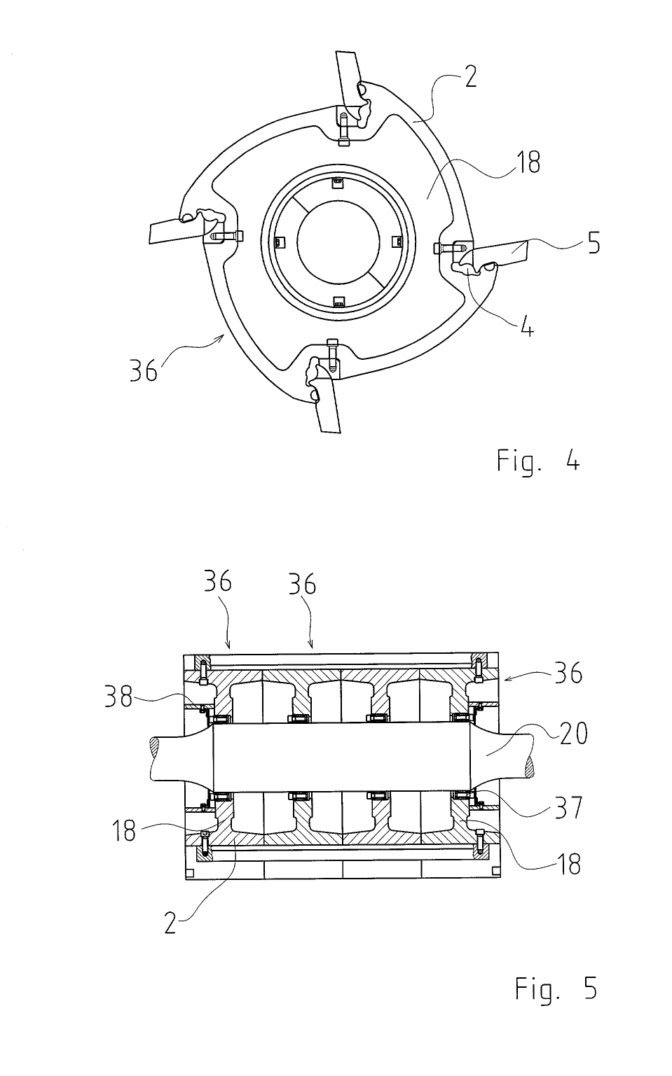

FIG. 4 shows a special design of the rotor according to the invention. The rotor casing 2 is cast in one piece together with the rotor disc 18 and forms an annular disc element 36. The circumferential slots 4 for the beater bars 4 are thus provided in the cast body itself. As FIG. 5 makes clear, rotors for wider impactors can be produced in a very simple way by a plurality of disc elements 36 being assembled, the rotor discs 18 being equipped with clamping elements 37, by means of which they are held tensionally locked on the shaft 20. The rotor casings 2 of the disc elements 36 bear against one another in this case and thus form a closed wide casing, even a rotor made from casting steel of the closed type. The clamping elements 37 are designed in such a way that they fix each disc element 36 on the shaft 20 tensionally locked, that is to say fixedly in terms of rotation. The clamping elements 37 of the outer disc elements 36 are covered by a protective device 38.

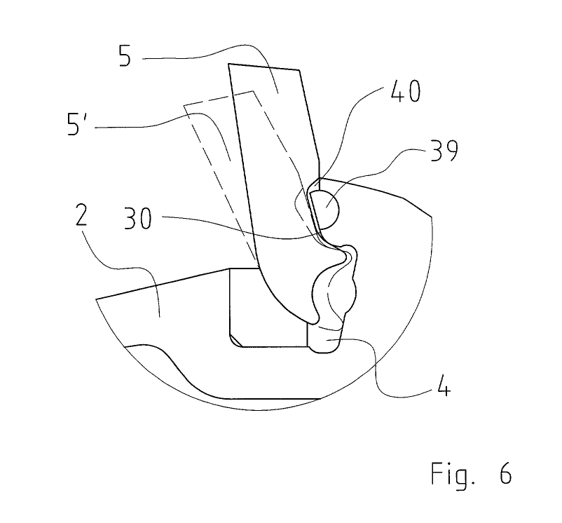

As shown in FIG. 6, the bearing surface 30 of the rotor casing 2 is equipped with a boss 39 which reaches somewhat into the circumferential slot 4, the beater bar 5 having on its rear side a slot-like recess 40 by means of which the beater bar is slipped over the boss when tilted into bearing contact. In the rotor according to the invention therefore, the beater bars are secured automatically against creeping laterally out of the rotor. 5′ designates the beater bar in the forwardly tilted position (illustraed by broken lines) in which it rests loosely and can be drawn out of the circumferential slot 4.

The beater bar itself is the subject of a separate patent application.

It will be understood that each of the elements described above, or two or more together, may also find a useful application in other types of constructions differing from the types described above.

While the invention has been illustrated and described as embodied in rotor of the closed type for impactors, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A rotor of a closed type for impactors, comprising a cylinder-shaped casing; a shaft; at least one rotor disc which carries said casing on said shaft and is composed of cast steel, said rotor casing being provided on an outside with circumferential slots oriented parallel to a rotor axis and formed for receiving and holding beater bars, said rotor casing and said at least one rotor disc carrying said rotor casing being of one piece with one another, and said rotor casing being substantially single-walled, said circumferential slots for receiving and holding the beater bars being provided in a cast body composed of said rotor casing and said at least one rotor disc

2. A rotor as defined in claim 1, wherein said rotor casing is supported on said shaft by only one rotor disc which is held tensionally locked on said shaft; and further comprising clamping means selected from the group consisting of a clamping element and a clamping assembly and holding said only one rotor disc tensionally locked on said shaft.

3. A rotor as defined in claim 1, said disc elements including a plurality of such disc elements.

4. A rotor as defined in claim 1, wherein said rotor casing is subdivided into segments which, starting from the beater bars, have, opposite to a direction of rotation of the rotor, a spiral generated surface inclined in a direction of an axis.

5. A rotor as defined in claim 1, for beater bars capable of being acted upon on one side, which are capable of being inserted in a form-fitted manner into said circumferential slots of the rotor and have rearwards, opposite to a direction of rotation of the rotor, and facing the latter, a bend, by which they engage into a longitudinally running undercut of the circumferential slots and are held counter to a centrifugal force of the rotating rotor, the rotor further comprising a bearing surface against which the rotor bars are holdable; a supporting surface via which the beater bars are engagable with said undercut in said circumferential slots; a piece selected from the group consisting of a supporting piece and a bearing piece and holding the beater bars in engagement with said undercut in said circumferential slots, said circumferential slots having as the bearing surface an approximately radially oriented plane which extends over a width of said rotor casing and runs out into the arcuately designed undercut, said circumferential slots having, opposite to said arcuate undercut, a bearing piece with an arcuate supporting surface, with a thickness of the beater bars taken into account, a center of rotation of a smaller radius of an arc of said bearing surfaces being arranged at a considerable distance from a center of rotation of a larger radius of an arc on said supporting surface, in direction of a beating circle of the beater bar, and said two centers of rotation running in a line approximately parallel to a beating surface of the beater bar, said bearing surfaces being at an obtuse angle to one another in a prolongation of said smaller arc.

6. A rotor as defined in claim 1, wherein a distance between said centers of rotation of said radii is in a ratio of 1:7 to 1:15 to a remaining height of the beater bars installed in the rotor.

7. A rotor as defined in claim 6, wherein the distance between the centers of rotation of the radii is in a ratio 1:10 to the remaining height of the beater bars installed in the rotor.

8. A rotor as defined in claim 5, wherein said obtuse angle between said bearing surfaces lying in the prolongation of the smaller arc is substantially 120°.

9. A rotor as defined in claim 5, wherein said piece selected from the group consisting of a supporting piece and a bearing piece is exchangeable.

10. A rotor as defined in claim 5, wherein said circumferential slots for receiving the beater bars, have, on their inner approximately radially extending boundary surface oriented longitudinally over a rotor width, a segment-shaped recess facing an end face of the bend of the beater bars and extending over the width of the rotor.

11. A rotor as defined in claim 10; and further comprising a profile bar which is introduced into a free space between said segment-=shaped recess in said circumferential slots and said segment-shaped recess of the installed beater bars.

12. A rotor as defined in claim 1; and further comprising a boss which is mounted in a region of said bearing surfaces for the beater bars and projects somewhat beyond said bearing surfaces, so that a recess provided in the beater bars can be slipped over said boss.

13. A rotor of a closed type for impactors, comprising a cylinder-shaped casing; a shaft; rotor discs carrying said casing on said shaft and composed of cast steel, said rotor casing being provided on an outside with circumferential slots oriented parallel to a rotor axis and formed for receiving and holding beater bars, said rotor casing being subdivided into shells which are connected outside said circumferential slots for the beater bars by longitudinal weld seams, to form said rotor casing as a closed rotor casing, so that said circumferential slots for receiving and holding the beater bars are provided in a cast body composed of said casing and said rotor discs, said rotor casing being connected to said rotor discs by weld seams.

14. A rotor as defined in claim 13, wherein said rotor casing is composed of four shells, of which said longitudinal weld seams connecting said shells are provided in radially outer slot-like depressions of said rotor casing which run parallel to said circumferential slots for the beater bars, said depressions being arranged in direction of rotation of the rotor upstream of the beater bars or upstream of said circumferential slots for receiving the beater bars.

15. A rotor as defined in claim 14, wherein said shells are hollow and have hollow spaces with radially and circumferentially oriented reinforcing ribs, said reinforcing ribs terminating inwards with a radius which corresponds to a radius of said rotor discs.

16. A rotor as defined in claim 14, wherein said slot-like depressions and therefore said longitudinal weld seams are covered by plates which, having form-fitted guide pieces, are pushable axially into said depressions and held by a form-fitted connection against centrifugal forces directed outwards.

17. A rotor as defined in claim 13, wherein said rotor casing is subdivided into segments which, starting from the beater bars, have, opposite to a direction of rotation of the rotor, a spiral generated surface inclined in a direction of an axis.

18. A rotor as defined in claim 13, for beater bars capable of being acted upon on one side, which are capable of being inserted in a form-fitted manner into said circumferential slots of the rotor and have rearwards, opposite to a direction of rotation of the rotor, and facing the latter, a bend, by which they engage into a longitudinally running undercut of the circumferential slots and are held counterto a centrifugal force of the rotating rotor, the rotor further comprising a bearing surface against which the rotor bars are holdable; a supporting surface via which the beater bars are engagable with said undercut in said circumferential slots; a piece selected from the group consisting of a supporting piece and a bearing piece and holding the beater bars in engagement with said undercut in said circumferential slots, said circumferential slots having as the bearing surface an approximately radially oriented plane which extends over a width of said rotor casing and runs out into the arcuately designed undercut, said circumferential slots having, opposite to said arcuate undercut, a bearing piece with an arcuate supporting surface, with a thickness of the beater bars taken into account, a center of rotation of a smaller radius of an arc of said bearing surfaces being arranged at a considerable distance from a center of rotation of a larger radius of an arc on said supporting surface, in direction of a beating circle of the beater bar, and said two centers of rotation running in a line approximately parallel to a beating surface of the beater bar, said bearing surfaces being at an obtuse angle to one another in a prolongation of said smaller arc.

19. A rotor as defined in claim 13, wherein a distance between said centers of rotation of said radii is in a ratio of 1:7 to 1:15 to a remaining height of the beater bars installed in the rotor.

20. A rotor as defined in claim 19, wherein the distance between the centers of rotation of the radii is in a ratio 1:10 to the remaining height of the beater bars installed in the rotor.

21. A rotor as defined in claim 18, wherein said obtuse angle between said bearing surfaces lying in the prolongation of the smaller arc is substantially 120°.

22. A rotor as defined in claim 18, wherein said piece selected from the group consisting of a supporting piece and a bearing piece is exchangeable.

23. A rotor as defined in claim 18, wherein said circumferential slots for receiving the beater bars, have, on their inner approximately radially extending boundary surface oriented longitudinally over a rotor width, a segment-shaped recess facing an end face of the bend of the beater bars and extending over the width of the rotor.

24. A rotor as defined in claim 23; and further comprising a profile bar which is introduced into a free space between said segment-shaped recess in said circumferential slots and said segment-shaped recess of the installed beater bars.

25. A rotor as defined in claim 24; and further comprising a boss which is mounted in a region of said bearing surfaces for the beater bars and projects somewhat beyond said bearing surfaces, so that a recess provided in the beater bars can be slipped over said boss.
